(19) United States
(12) Patent Application Publication
(10) Pub. No.: US 2018/0104815 A1
(43) Pub. Date: Apr. 19, 2018

(54) ROBOT SYSTEM

(71) Applicant: Bin Yang, Johns Creek, GA (US)

(72) Inventor: Bin Yang, Johns Creek, GA (US)

(21) Appl. No.: 15/686,822

(22) Filed: Aug. 25, 2017

Related U.S. Application Data
(60) Provisional application No. 62/478,697, filed on Mar. 30, 2017.
(60) Provisional application No. 62/470,938, filed on Mar. 14, 2017.
(60) Provisional application No. 62/410,062, filed on Oct. 19, 2016.

(51) Int. Cl. B25J 9/08; B25J 11/00; B25J 19/02

(52) U.S. Cl. CPC B25J 9/08; B25J 11/0085; B25J 19/005; Y10S 901/01; B25J 19/023

(57) ABSTRACT

A robot system includes a primary robot frame including a computerized control module providing control commands for the robot system, the primary robot frame including an outer perimeter. The robot system further includes a plurality of submodules, each submodule capable of being selectively docked with the primary robot frame, the submodules each providing different functionality to the robot system. The submodules, when docked with the primary robot frame, fit within the outer perimeter, enabling the robot system to operate in a closed mode, wherein all movement of the robot system is based upon the outer perimeter.

### CROSS REFERENCE TO RELATED APPLICATIONS

This disclosure claims priority to and the benefit of U.S. Provisional Application No. 62/478,697 filed on Mar. 30, 2017, of U.S. Provisional Application No. 62/470,938 filed on Mar. 14, 2017, and of U.S. Provisional Application No. 62/410,062 filed on Oct. 19, 2016, all of which are hereby incorporated by reference.

### TECHNICAL FIELD

This disclosure is related to a robot system, particularly to a device configured to perform one of a plurality of autonomous or semi-autonomous tasks.

### BACKGROUND

The statements in this section merely provide background information related to the present disclosure. Accordingly, such statements are not intended to constitute an admission of prior art.

Robot systems are known in the art. Many require expensive dedicated electronics and control hardware. Robot systems that are programmed to collect balls or other objects are limited in the amount of collected objects they can store on board. Robot systems with varying perimeters or shapes of the robots can be difficult to program, especially in areas where contact with unpredictable movement of persons in the environment with the robot systems is likely.

Robot systems can be programmed with complex software routines to control the devices.

### SUMMARY

A robot system includes a primary robot frame including a computerized control module providing control commands for the robot system, the primary robot frame including an outer perimeter. The robot system further includes a plurality of submodules, each submodule capable of being selectively docked with the primary robot frame, the submodules each providing different functionality to the robot system. The submodules, when docked with the primary robot frame, fit within the outer perimeter, enabling the robot system to operate in a closed mode, wherein all movement of the robot system is based upon the outer perimeter.

### BRIEF DESCRIPTION OF THE DRAWINGS

One or more embodiments will now be described, by way of example, with reference to the accompanying drawings, in which:

FIG. 1 illustrates an exemplary tennis ball collecting robot system in a side view, in accordance with the present disclosure;

FIG. 2 illustrates the robot system of FIG. 1 in a front view, in accordance with the present disclosure;

FIG. 3 illustrates schematically illustrates an exemplary alternative tennis ball collecting robot system, in accordance with the present disclosure;

FIG. 4 illustrates the device of FIG. 3 collecting tennis balls, in accordance with the present disclosure;

FIG. 5 illustrates the device of FIG. 3, the device reconfigured internally to eject tennis balls that have been collected, in accordance with the present disclosure;

FIG. 6 illustrates an exemplary submodule configured to collect balls in sectional schematic view, in accordance with the present disclosure;

FIG. 7 illustrates an exemplary submodule configured to act as a vacuum cleaner, in accordance with the present disclosure;

FIG. 8 illustrates two exemplary robot systems operating in closed mode, traveling through a specially designed corridor to enable rapid movement of the robot systems through a complex environment, in accordance with the present disclosure;

FIG. 9 illustrates an exemplary robot system operating in an open mode, towing a cart behind the robot system for the purpose of increasing a tennis ball storage capacity of the robot system, in accordance with the present disclosure;

FIG. 10 illustrates an exemplary robot system in open mode, towing a cart behind the robot system for the purpose of increasing a number of luggage items that can be hauled by the robot system, in accordance with the present disclosure;

FIG. 11 illustrates an exemplary robot system in open mode, towing a dust bin behind the robot system for the purpose of increasing an amount of debris and dust that a vacuum cleaning robot system can store before having to be cleaned, in accordance with the present disclosure;

FIG. 12 illustrates an exemplary robot system, including a primary robot frame embodied as a top portion of the robot system and a submodule embodied as a lower portion of the robot system, in accordance with the present disclosure;

FIG. 13 illustrates an exemplary robot system, including a primary robot frame including both top and bottom portions of the robot system, with the submodule being located between the top and bottom portions, and with the overall shape of the robot system being cylindrical, in accordance with the present disclosure;

FIG. 14 illustrates a truck shaped robot system, enabling docking can carrying of a submodule upon a storage area of the truck shaped robot system with the robot able to operate in closed mode, in accordance with the present disclosure;

FIG. 15 illustrates a robot system shaped like a human body, with submodules being attachable to a primary robot frame in order to change the appearance of the robot system, in accordance with the present disclosure;

FIGS. 16A-16C illustrate a robot system configured to collect baseballs, including a deployable rear platform and a paddle wheel collecting mechanism, in accordance with the present disclosure;

FIG. 16A illustrates the robot system in closed mode;

FIG. 16B illustrates the robot system in open mode; and

FIG. 16C schematically illustrates exemplary internal mechanisms of the robot system in detail including a paddle wheel collecting mechanism;

FIG. 17 illustrates an exemplary robot system including a locking cargo dispensing mechanism, in accordance with the present disclosure;

FIG. 18 schematically illustrates computerized control of an exemplary robot system, in accordance with the present disclosure;

FIG. 19 schematically illustrates an exemplary submodule useful as an air purifier, in accordance with the present disclosure;

FIG. 20 schematically illustrates an exemplary primary robot frame, in accordance with the present disclosure; and

FIG. 21 illustrates coordination of exemplary data made available from external infrastructure systems with a robot system in closed mode to navigate the robot system through a complex environment, in accordance with the present disclosure.

### DETAILED DESCRIPTION

An improved robot system is disclosed. Improvements of the disclosed device are multifaceted.

According to devices, systems, and processes of the disclosure, a composite robot system is described that provides different combinations of functions by changing body components manually or autonomously by the robot itself through varieties of sensors and the intelligent software that is running inside the central processor. The common robotic body provide autonomous wheeled mobility and sensor rich environment to achieve specific tasks if different function of sub-module is inserted or dragged behind the main unit. The system can include multiple electronic control boards in the system that support hardware and sensor logic necessary to provide data source and processing power for the central software that process and analysis all input data helping make decisions of the next step. Those processes including and not limited to machine vision, location awareness and area mapping, object recognition and obstacle avoidance, language understanding/interpretation and voice synthesis, short-range/mid-range/long-range communication, interaction locally/remotely with human interface software or equipment, efficient power management etc.

There are many varieties of robotic system in different field such as industrial, medical, military and consumer market. Robotic arms are very popular in industrial factory floor assembling, soldering and painting cars and vehicles. Automatic or remote controlled military robot that can remove dangerous materials. Mobile robot that provide security surveillance for the vicinity, vacuum floor cleaning robot, entertaining robot for education purpose. All of the mentioned and not-mentioned robot systems are very costly to produce, they stay inactive most of the time. The cost to usage ratio is relative high. There is a need to produce one system that can execute multi-tasks with much lower cost/usage ratio.

The disclosed robotic system provides adaptive functions to different real life challenges with one commonly owned robotic body that is equipped with common sensors and processing power for various tasks, providing flexibility and adaptability at lower cost. According to embodiments of the disclosure, a portion of the robot can be described as the primary robot frame, which includes a docking bay configured to receive and provide command functions to a docking submodule. The primary robot frame can include a processing unit and computing resources capable of providing command functions to any of a plurality of submodules with a wide variety of functions. According to one embodiment, the submodules can each include little or no computing resources, with most or all command functions being processed by the primary robot frame. Each separable submodule may also has its own functionality and perform its function without the primary robot frame. Communications between the primary robot frame and the submodules can define new task. Each submodule may provide additional sensors or additional computing resources to augment operation of the robotic system in excess of what the primary robot frame can accomplish on its own.

Communications between a submodule and a primary robot frame can facilitate a number of operations, including guiding the main robot frame to locate or select the submodule for an automatic release/assemble procedure.

Submodules can include various features. For example, submodules can include wheels and/or motive power, or wheels and motive power can be entirely provided by the primary robot frame. A towed submodule can have their own wheels to support themselves.

According to one embodiment, the robot system including the primary robot frame docked with a submodule can maintain a known geometry around the primary robot frame chassis. In one embodiment, the robot system can alternate between a closed geometry mode, wherein the robot can operate with an assumption that the outer geometry of the robot system is defined by the outer geometry of the primary robot frame, an open geometry mode, wherein the robot instead operates under an assumption that features, components, or towed objects are outside the geometry of the primary robot frame.

Operation of the robot in a closed geometry mode can include a number of advantages. Programming enabling obstacle avoidance and path finding can be simplified when an outer or perimeter geometry can be assumed. Specialized transport facilities or corridors can be designed for a known robot system geometry, for example, enabling a robot system or a plurality of robot systems to move quickly about a complicated environment, such as an airport, a hospital, or a factory.

The primary robot frame can be a sensor rich unit that can make autonomous decisions by its own, or can also be controlled remotely by a human interface or a device, which takes higher priority. Gyroscope sensor and GPS sensor can guide the unit where the information is available. Ultrasonic/microwave radar, inferred sensor and magnetic sensor can provide distance data and environment information for path finding and obstacle avoidance. A Lidar unit can provide precise measurement of 3D space images that aid space mapping/estimation algorithm. Dual camera sensors help recognize objects with 3D image information extraction and distance measurement. Short range communication channels such as Bluetooth and WIFI communication within the robot itself and also working with remote client server for cloud based applications whenever possible, provide additional services and utilizations such as long distance remote control function. Mid-range communication channel such as zigbee, Lora or NB-IOT can perform near-vicinity control functions for home equipment or pet management and tracking. Mid-range communication can also be used as robot to robot information exchange channel to perform one common task by multiple robots. Long-range communication system such as 2G, 3G, 4G, 5G or any similar signaling can cover all out-door activities while local networking is not available. Sensors existing within a local infrastructure can also be utilized, for example, with a plurality of cameras in an airport terminal being monitored and synthesized by a remote server device to determine open paths between people and objects for a robot system to move, and the open pathways can be communicated in real time to the robot system through any of the disclosed communication systems.

The main robot system can also take different shapes, depending on intended or foreseeable applications. A simplified system can use cell phone or a smart phone as its main processor. A software app will operate the robot functions and activity through wired/wireless channels. A cylinder body, or a human-like shape, a cubic shape, or any other shape is all possible for different application. Another combining form could make the central processor portion as a standalone box with connection harnesses that can connect to different supporting robotic bodies such as drawing FIG. 12, which imply a manual combination is needed to achieve different functions by changing the body function. Another combining format is to make partial central processor and partial sensor group manually available to fit to different component with wheels and special functions.

Various robot system functions are envisioned. A robot system including a single primary robot frame can dock with various submodules that can achieve the following exemplary functions: a tennis ball collector, a vacuum machine, an air purifier, a material delivery compartment with electrical and/or mechanic lock. A larger unit may be needed in larger area such as hospital, airport, golf course etc, for delivery, carrying payload or drag a bigger equipment such as a vacuum cleaner and wiping machine, luggage towing cart, medical equipment delivery system, or even a trash can etc.

Human shaped robots are known. A human shaped robot system is disclosed including interchangeable submodules. For example, a robot system can include a generic primary robot frame, and a robot system gender can be selected for a particular application. For example, an automotive retail dealer could ask a person walking into the dealer whether they would like to work with a male or a female salesperson. Upon selecting one or the other, a submodule or plurality of submodules can be quickly attached to the primary robot frame to emulate the selected gender features, such as a face, hair, and hands.

According to another embodiment, a robot system is disclosed for collecting balls. The balls can include tennis balls, for example, in proximity to a tennis court, making tennis practice or tennis matches more efficient. The balls can include basketballs, for example, enabling a player to continually practice free-throws or three point shots without having to stop to collect balls. The balls can include baseballs, for example, balls hit within a batting cage device or balls hit upon a practice field. In one embodiment, operating in a closed mode, the robot system can store balls internally within the geometry set by the primary robot frame. In another embodiment, operating in an open mode, the device can include an elastic folding basket (which can be alternatively described in some embodiments as a floorless flexible fenced ball collection mechanism) which permits the balls to roll on a ground upon which the robot system is rolling, such that the robot system does not have to physically store the balls within the device.

According to another embodiment of the disclosure, a cell phone or smart phone device can include a downloadable application or program which enables the smart phone to be plugged into a robot system to act as the controller for the device. Smart phones of recent development include incredible processing power and sensors such as camera devices and microphone devices installed thereto. Smart phones additionally include GPS or location data gathered from nearby cell phone towers or infrastructure. Such a controlling smart phone can but need not be physically located upon the robot system. In one embodiment, the smart phone can communicate by Bluetooth® or similar communications means to acquire sensor information for the robot system and provide controlling commands to the robot system remotely. In one embodiment, the smart phone can be located within a dome shaped head cockpit of the robot system. The dome can be transparent so that the smart phone can use the installed camera device to gather information. The smart phone can be installed upon a rotating and/or tilting mechanism or gimbal mechanism to provide the smart phone camera with a controllable viewpoint.

According to another embodiment of the disclosure, the robot system can be programmed to follow a programmed user. In one example, the controller (dedicated to the robot system or the smart phone controlling the device) can be programmed to follow the location data from a smart phone in the possession of the user. Other sensor data, such as camera or ultrasonic inputs, can be used to keep the robot system in a proper location, for example, at a polite distance and not bumping into objects. In one example, such a robot system can carry and dispense golf clubs to a golfer. Such a robot system can incorporate other programming such as tracking historical shots by the golfer on the course, and suggesting game play tips or suggested clubs based upon the historical shots. If the robot system is controlled by the smart phone of the golfer, the golfer can away from the golf course tweak command parameters of the robot system, for example, saying never offer me the driver on hole 6 or remind me to stay away from the left side on hole 7. In another embodiment, a robot system can be programmed to take the carry-on bag of a person in an airport, run away to storage while the user walks around the terminal, and then meet the user at the gate 15 minutes prior to boarding.

In one embodiment, a head cockpit of a robot system can include sensors similar to a computer mouse sensors, such that if a user touches the top of the head cockpit, the robot system can take a directional command from the user by the directional input from the sensors.

In one embodiment, the robot system can include a remote control function. Exemplary remote control devices can include a smart phone, a computer terminal, a game console type controller, or a dedicated controller similar to those known for use with remote control model planes. Such remote control devices can connect with the robot system through a 3G or similar cellular connection. The remote control signal can provide direct control of the robot system. In another embodiment, an on board controller can continue to provide primary control of the robot system, with the remote control providing priority settings or brief override commands to the robot system.

In another embodiment, the disclosed robot system can be used as a security device, protecting a home, office, or other setting from intrusion. Whereas known security systems include fixed motion sensors, a robot system can be programmed to patrol around the location being guarded. A security user or home owner can, through a smart phone remote control device, take over control of the robot system at any time. The robot system can be provided with a wireless communications device capable of contacting a 9-1-1 operator, a remote security company, and/or the home or office owner.

In another embodiment, a robot system can include programming to go pick something up for the operator. For example, a golfer on a golf course may want a sandwich from the club house. The robot system can include programming to communicate an order for a particular food item to the club house computer system, go to a specific point in the club house, and return to the golfer by a location of a device proximate to the user, for example, a cell phone in the pocket of the user's golf partner.

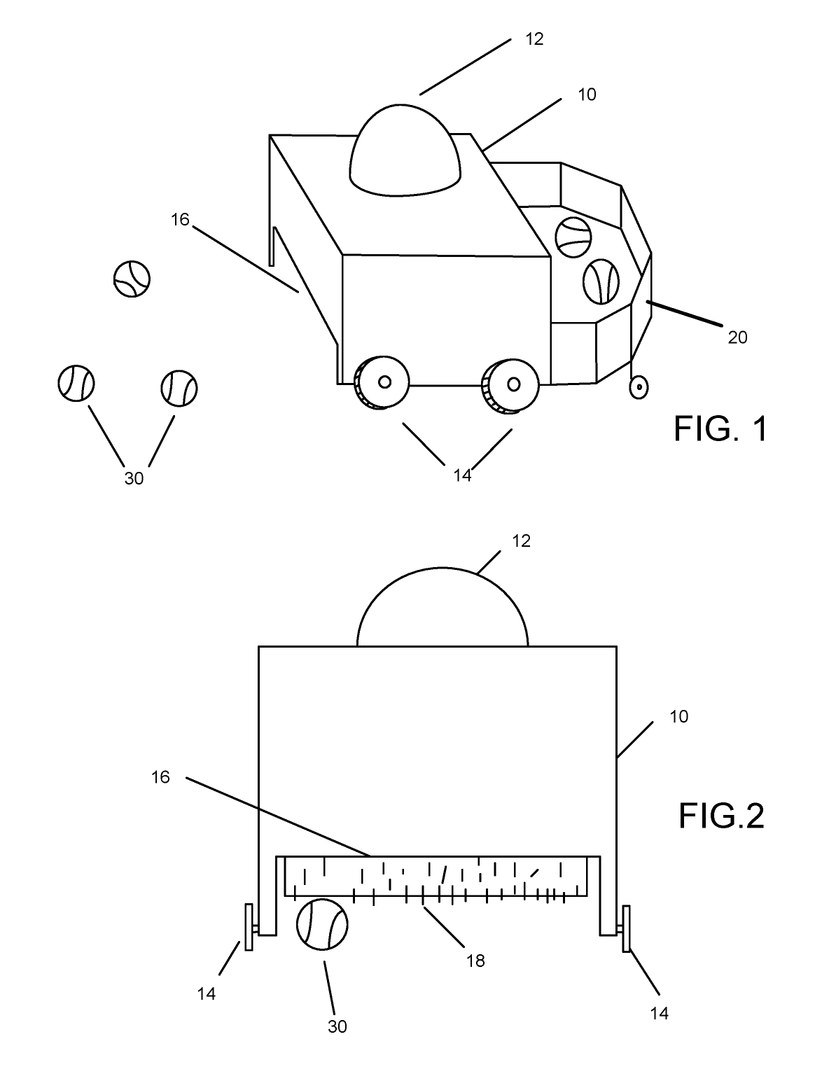

Referring now to the drawings, wherein the showings are for the purpose of illustrating certain exemplary embodiments only and not for the purpose of limiting the same, FIG. 1 illustrates an exemplary tennis ball collecting robot system in a side view. Robot system 10 includes a head cockpit 12 configured to receive an exemplary smart phone device, wheels 14 including at least one wheel receiving torque from an electric machine or similar device, ball collection opening 16, and elastic folding basket 20 configured to permit collected balls 30 to roll upon the ground while basket 20 corrals the balls behind the robot system as the device moves.

FIG. 2 illustrates the robot system of FIG. 1 in a front view. Robot system 10 is illustrated including head cockpit 12, wheels 14, and ball collection opening 16 including a sweeping or rotating drum 18 (which can alternatively in some embodiments be termed a collection roller.) Robot system 10 maneuvers around a surface to collect balls 30, wherein balls 30 are placed into contact with sweeping drum 18 which spins in a direction that makes the ball roll into a collection area within an attached elastic folding basket. In one embodiment, the sweeping drum 18 can raise or lower to optimally come into contact with the balls being collected. In one embodiment, when it comes time to release the collected balls, drum 18 can be caused to spin an opposite direction. In such an embodiment, the attached elastic folding basket can be caused to contract, such that collected balls are forced into the reverse spinning sweeping drum 18.

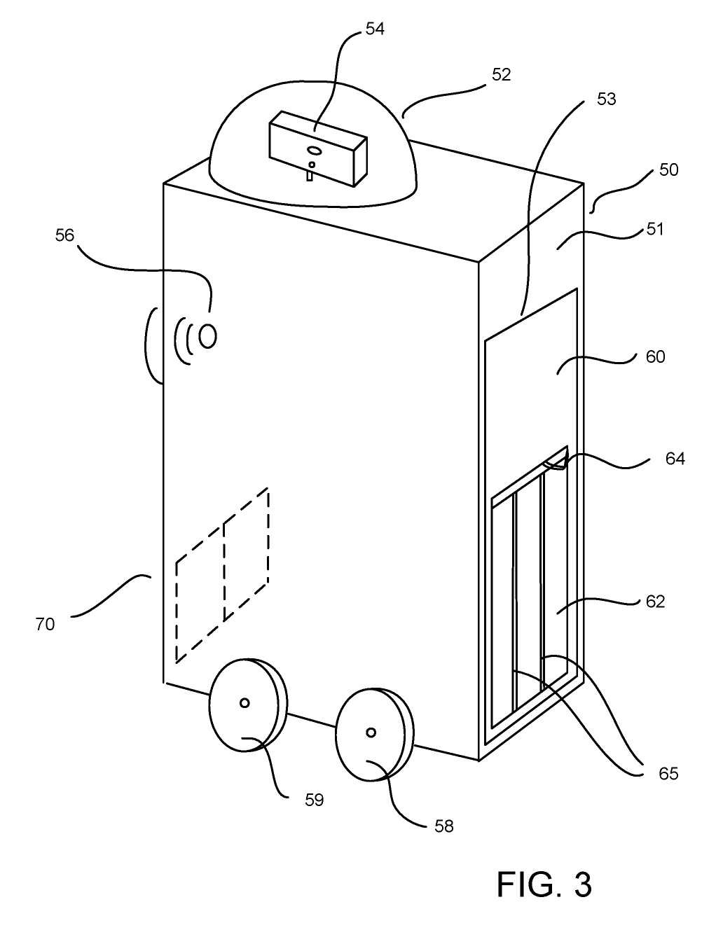

FIG. 3 illustrates schematically illustrates an exemplary basketball collecting robot system. Robot system 50 is illustrated including primary robot frame 51 and submodule 60 installed to primary robot frame 51. Primary robot frame 51 includes wheels 58 and 59, visual sensor assembly 52, ultrasonic sensor assembly 56, and cavity 53 into which submodule 60 can be docked or installed. Primary robot frame 51 includes optional front doors 70 which can be motorized for control and can be opened or shut during operation based upon the function of the particular submodule 60 installed to robot system 50.

Submodule 60 of FIG. 3 is particularly configured to gather up basketballs. It includes a collapsing ball corral 62 which is either deployed or retracted using motorized spindle 64. Collapsing ball corral 62 can include stiff vertical ridges or members 65, strengthening and causing to stand upright the otherwise flexible material of corral 62. As basketballs are brought through opened front doors 70, internal mechanisms move the basketballs into a contained space created by corral 62. Either or both of wheels 58 and 59 can be powered, enabling controlled movement of robot system 50.

Any number of camera or vision systems 54 can be utilized within visual sensor array 52, and such camera or vision systems 54 can include a single camera on a rotating or moveable gimbal unit, multiple cameras in fixed orientations, or any plurality or combination thereof An exemplary optional protective clear dome is illustrated on visual sensor array 52.

When robot system 50 is finished collecting basketballs, it can undock from submodule 60 and collect another submodule, for example, including a vacuum unit to clean walkways near the basketball playing surface or a waxing and polishing unit to care for the basketball playing surface. Each module can, for example, include a battery pack, enabling robot system 50 to use up a battery charge of a first submodule and then acquire a second submodule with a fresh battery charge when necessary.

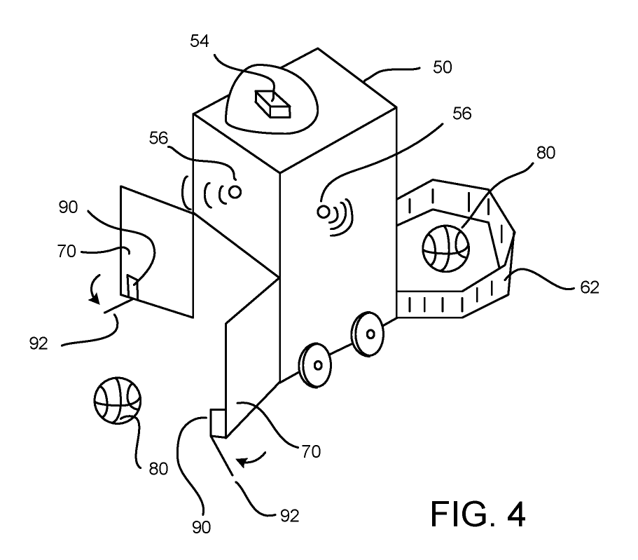

FIG. 4 illustrates the device of FIG. 3 collecting basketballs. Robot system 50 is illustrated including camera or vision systems 54 and ultrasonic sensor arrays 56. Additionally, collapsing ball corral 62 is illustrated in a deployed state, with one basketball 80 contained within the deployed corral 62. Front doors 70 are illustrated in an open state, with a second basketball 80 in position to be taken into the space between front doors 70. Additional optional spinning gathering arms 92 powered by motors 90 are illustrated at the ends of doors 70, further acting to gather and direct basketballs 80 within robot system 50.

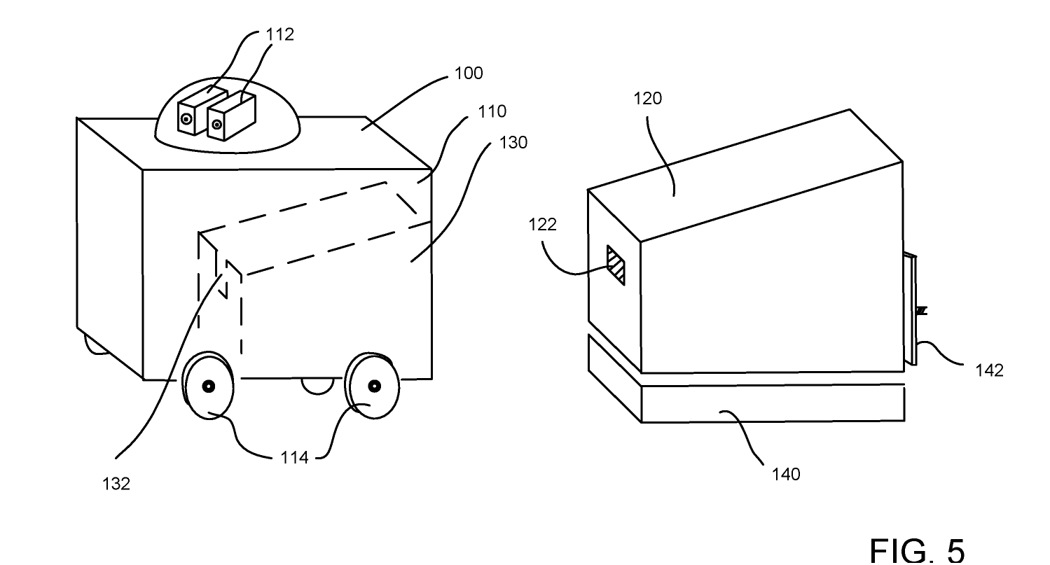

FIG. 5 illustrates an exemplary primary robot frame approaching a submodule located upon a submodule charging station. Robot system 100 is illustrated including primary robot frame 110 approaching submodule 120 in preparation for docking submodule 120 within cavity 130 of primary robot frame 110. Primary robot frame 110 includes binocular camera devices 112 and powered wheels 114. Cavity 130 is formed in a shape to mate with an exterior of submodule 120. Submodule 120 is located upon submodule charging station 140. In some embodiments, submodule charging station 140 can provide an electric charge to batteries on board submodule 120. In other embodiments, station 140 can additionally or alternatively remove or load objects onto submodule 120, clean submodule 120, update programming commands within submodule 120, and/or perform other services related to submodule 120. Submodule 120 includes power and data interface 122 configured to electronically connect with a mating power and data interface 132 within cavity 130. Station 140 includes an optional plunger unit 142 useful to aid in the installation of submodule 120 within cavity 130. The shapes, locations, and physical configurations of robot system 100 are exemplary, and any number of alternatives can be utilized in accordance with the present disclosure.

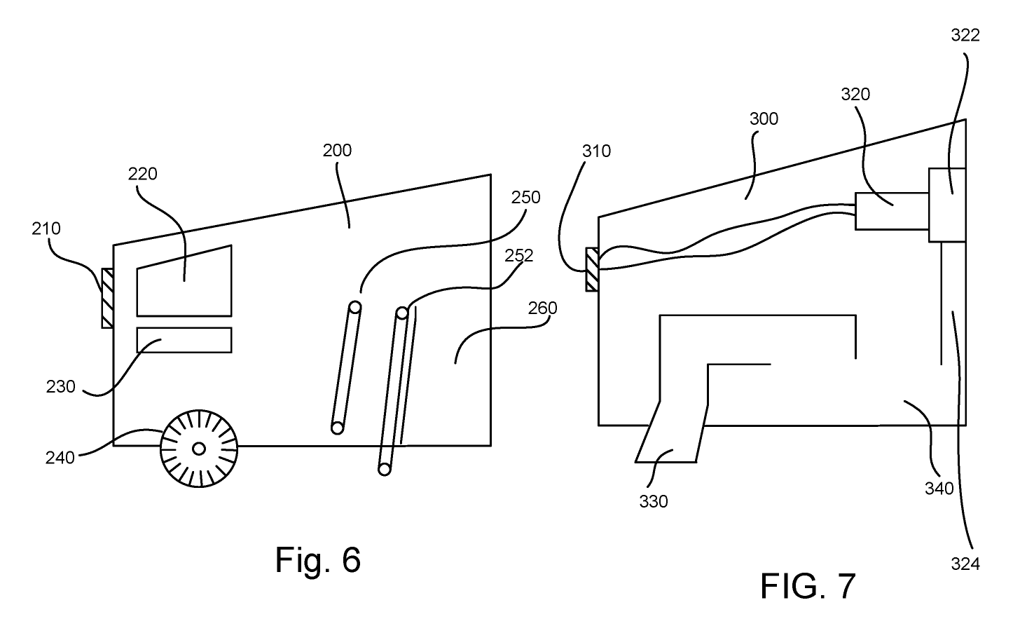

FIG. 6 illustrates an exemplary submodule configured to collect balls in sectional schematic view. Submodule 200 is illustrated including power and data interface 210, battery pack 220, control module 230, rotating collection brush 240, scooping conveyors 250 and 252, and internal collection bay 260. Submodule 200 is provided as an example of a submodule including both onboard battery power stored in battery pack 220 and computing resources made available through control module 230. It will be appreciated that either battery pack 220 or control module 230 could be omitted from submodule 200, transferring responsibility for power and/or computing resources to a mating primary robot frame. Battery pack 220 includes any rechargeable battery known in the art useful for supplying power to the submodule. Control module 230 includes a processor, memory, and other computing components known in the art useful for executing programmed instructions. Rotating collection brush 240 is an exemplary, non-limiting device that can be provided with a torque, such as from an electric motor known in the art, for the purposes of providing a mechanical force to a ball or similar object coming into contact with brush 240. Scooping conveyors 250 and 252 each include an exemplary belt driven by motorized rollers, with the belts rotating in opposite directions, with the space between the belts configured to enable the moving conveyors to propel a ball between the conveyors up and into internal collection bay 260. Bay 260 can include an exemplary openable outer door to enable the unloading of collected balls.

FIG. 7 illustrates an exemplary submodule configured to act as a vacuum cleaner. Submodule 300 is illustrated including power and data interface 310, blower motor 230 connected to blower fan 322, and vacuum scoop 330. It will be appreciated that a spinning agitator brush can be used in combination with vacuum scoop 330, depending upon the surfaces intended to be vacuumed. Submodule 300 is provided as an example of a submodule including neither onboard battery power stored or computing resources, but instead relies on a mating primary robot frame for both power and control commands. Blower fan 322 is a rotary type fan known in the art, which creates low pressure in fan scoop 324. The low pressure within fan scoop 324 in turn lowers pressure within internal dust bin 340, which lowers pressure within vacuum scoop 330. This lower pressure draws air from outside the scoop 330 into dust bin 340 and through fan scoop 324. In this way, dust and debris can be collected within dust bin 340.

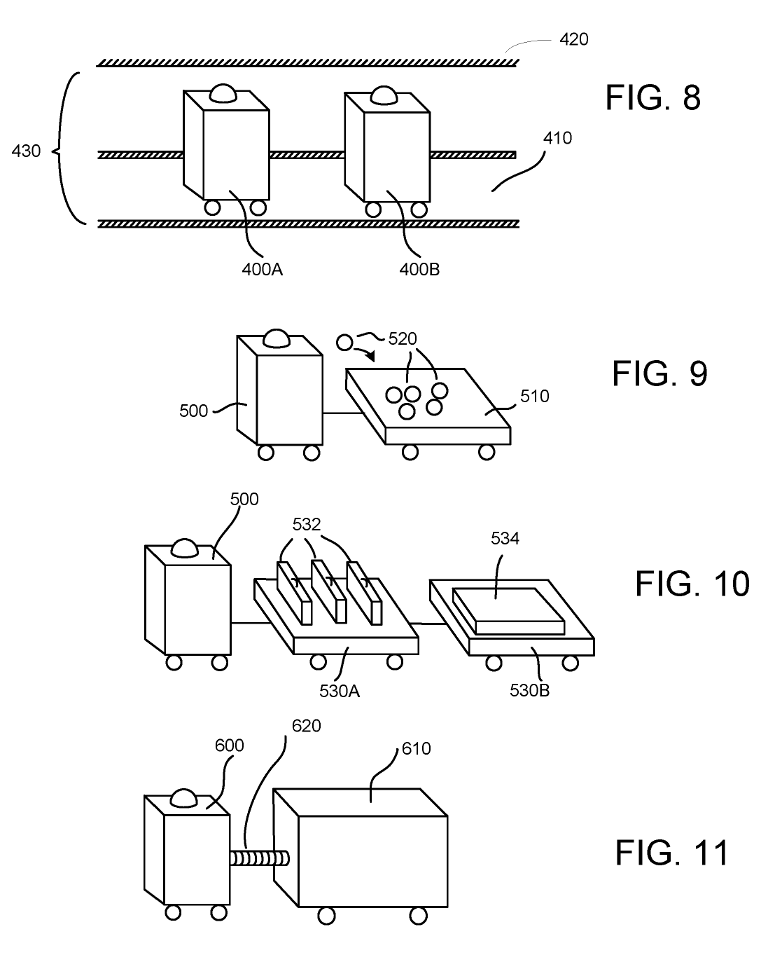

FIG. 8 illustrates two exemplary robot systems operating in closed mode, traveling through a specially designed corridor to enable rapid movement of the robot systems through a complex environment. Robot systems 400A and 400B are each traveling along a pathway 410 configured according to the shape of robot systems 400A and 400B. Based upon the robots being in closed mode, their outer geometries or package sizes are known quantities. This means that they can move within passages with a clearance space 430, defined between pathway 410 and a ceiling space 420, with minimal programming required to determine how the robot systems can move within clearance space 430. Further, one robot system can move onto the ramp quickly after another, with knowledge that the robots both in closed mode can fit compactly within the same clearance space 430. Such specially configured pathways can be used in multiple venues. For example, a shipping company could use a multitude of robot systems to load trucks or planes from a storage or handling facility. The robots could repeatedly cycle through such pathways, distributing goods from a central point to each of the individual conveyances. Similarly, robot systems could be used to tend and deliver carryon bags within an airport terminal, traveling through the terminal within a small, specialized pathway away from the persons walking through the terminal and arriving to the gate at an appropriate time.

Robot systems described herein can operate selectively in a closed mode or in an open mode. FIG. 9 illustrates an exemplary robot system operating in an open mode, towing a cart behind the robot system for the purpose of increasing a tennis ball storage capacity of the robot system. Robot system 500 is illustrated, capable of operating in a closed mode, but presently operating in an open mode, towing ball cart 510 behind robot system 500. For the purposes of increased utility, robot system 500 enters open mode for the purpose of increasing a number of balls 520 that can be stored by system 500. However, if the robot system needs to switch to closed mode, for example, as required to move through a busy lobby of a country club without bumping into the persons in the lobby, the cart 510 can be stored and the robot can enter closed mode.

FIG. 10 illustrates an exemplary robot system in open mode, towing a cart behind the robot system for the purpose of increasing a number of luggage items that can be hauled by the robot system. Robot system 500 is illustrated, in FIG. 10, towing a first luggage cart 530A, including three pieces of luggage 532, and a second luggage cart 530B, including an oversized item 534. For the purposes of increased utility, robot system 500 enters open mode for the purpose of increasing an amount of luggage that can be moved by system 500. However, if the robot system needs to switch to closed mode, for example, as required to move through a busy airplane or train terminal, the carts 530A and 530B can be stored and the robot can enter closed mode.

FIG. 11 illustrates an exemplary robot system in open mode, towing a dust bin behind the robot system for the purpose of increasing an amount of debris and dust that a vacuum cleaning robot system can store before having to be cleaned. Robot system 600 is illustrated configured as a vacuum cleaning robot system, including towed dust bin 610 and hose 620 connecting robot system 600 to dust bin 610. For the purposes of increased utility, robot system 600 enters open mode for the purpose of increasing an amount of debris that can be collected by system 600. However, if the robot system needs to switch to closed mode, for example, as required to clean enclosed areas that do not facilitate pulling the large dust bin 610 through the area being cleaned, dust bin 610 can be stored and robot system 600 can enter closed mode.

FIG. 12 illustrates an exemplary robot system, including a primary robot frame embodied as a top portion of the robot system and a submodule embodied as a lower portion of the robot system. Robot system 700 is illustrated, including a primary robot frame 710 illustrated as a top portion of the robot system 700 and a submodule 720 embodied as a lower portion of the robot system 700. In the illustrated embodiment, the wheels of robot system 700 can be located entirely on the submodule 720, with the robot system 700 acquiring new wheels, tracks, legs, or other motive mechanisms every time a new submodule is docked with the primary robot frame. In the alternative, a primary robot frame could be located on the bottom portion of the robot, with the robot system acquiring new or different sensor packs as different submodules are docked with the primary robot frame.

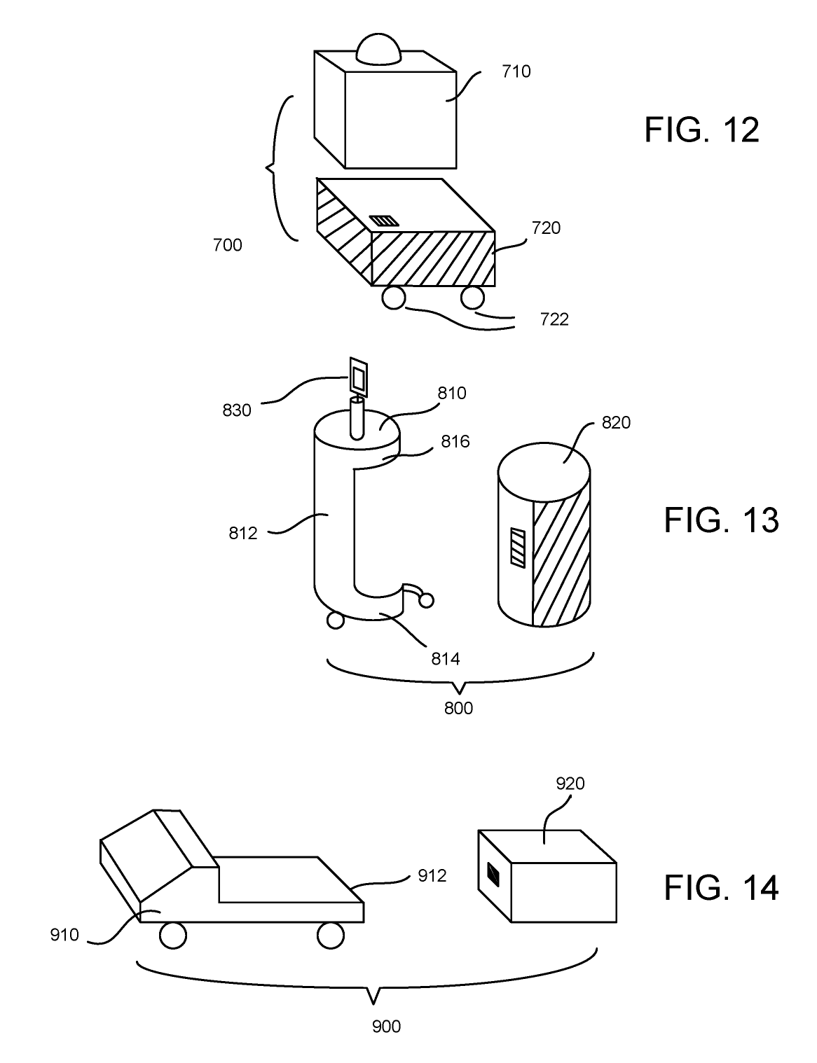

FIG. 13 illustrates an exemplary robot system, including a primary robot frame including both top and bottom portions of the robot system, with the submodule being located between the top and bottom portions, and with the overall shape of the robot system being cylindrical. Robot system 800 is illustrated including primary robot frame 810 and submodule 820. Both primary robot frame 810 and submodule 820 are configured to create a cylindrical body of robot system 800, which can be advantageous for moving about crowds with the absence of sharp corners and an ability rotate in place. Such a robot could be used to dispense refreshments at a party. The exemplary primary robot frame includes a slender middle portion 812, joining end caps 814 and 816 which sit below and above, respectively, round end portions of submodule 820, when docked. An exemplary smart phone unit 830 is located affixed to robot system 800, providing computerized control of robot system 800.

FIG. 14 illustrates a truck shaped robot system, enabling docking can carrying of a submodule upon a storage area of the truck shaped robot system with the robot able to operate in closed mode. Robot system 900 is illustrated including a truck-shaped primary robot frame 910 and a box shaped submodule 920. A rear boundary 912 of frame 910 and a rear boundary 922 of submodule 920 are configured to align, such that when submodule 920 is docked, robot system 900 can operated in a closed mode, assuming that two dimensional travel upon a road surface will result in the perimeter boundary of system 900 being the same as the perimeter boundary of frame 910.

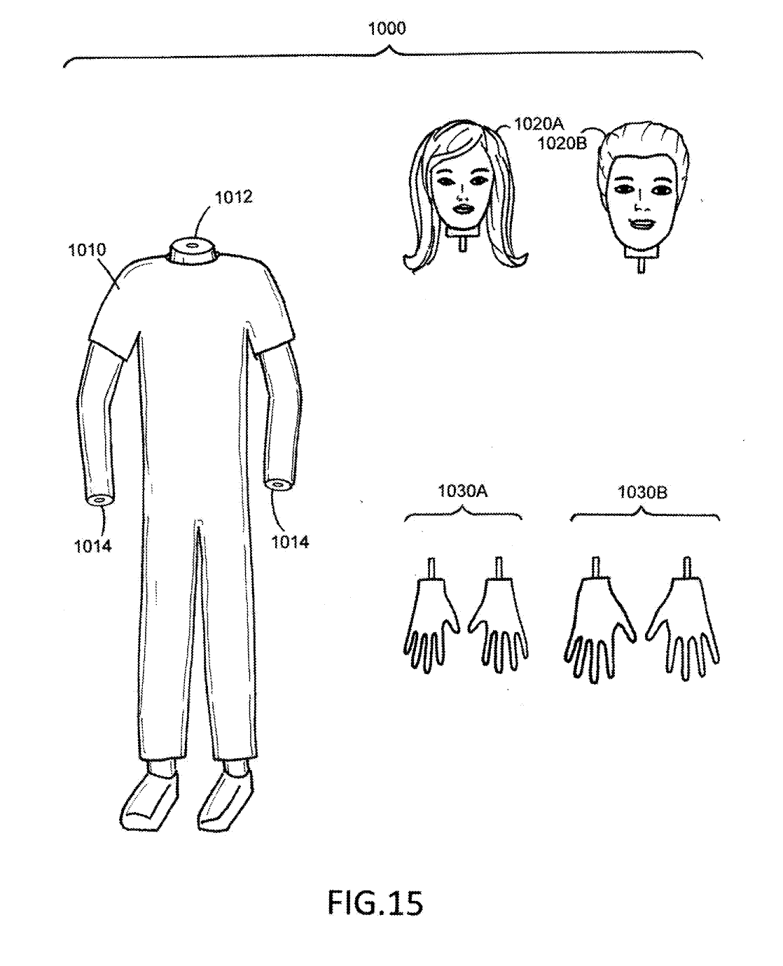

FIG. 15 illustrates a robot system shaped like a human body, with submodules being attachable to a primary robot frame in order to change the appearance of the robot system. Robot system 1000 includes primary robot frame 1010. Frame 1010 includes interfaces 1012 and 1014 configured to accept submodules configured to look like a head and hands, respectively. Submodules 1020A and 1020B provide different appearances, as do submodules 1030A and 1030B. Any number of submodules and different appearances can be modeled in the submodules that can attach to frame 1010, and the disclosure is not intended to be limited to the particular examples provided herein.

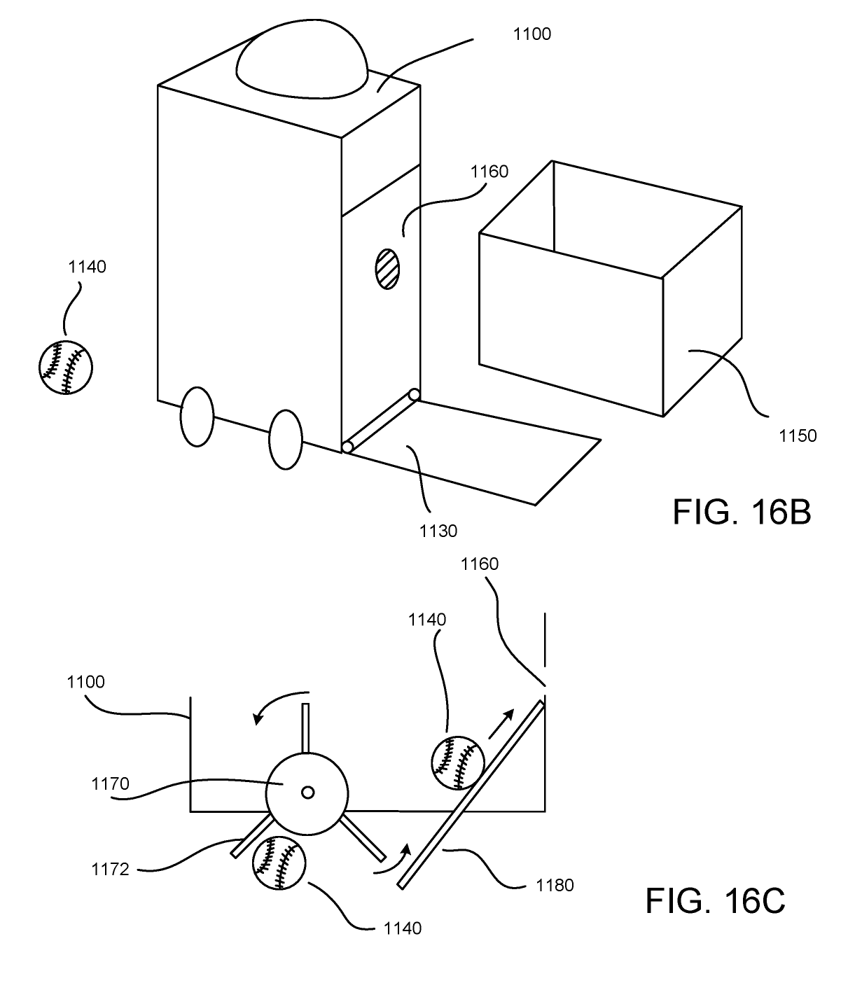

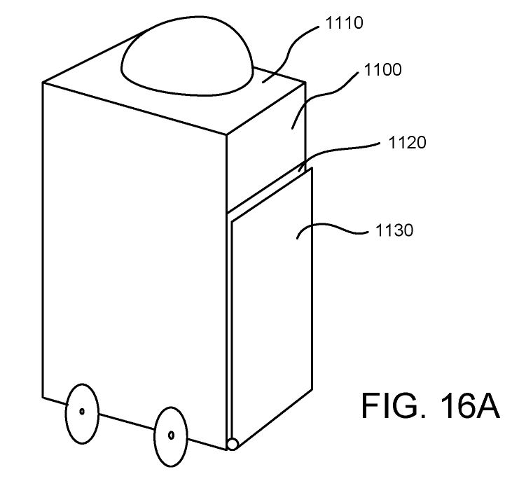

FIGS. 16A-16C illustrate a robot system configured to collect baseballs, including a deployable rear platform and a paddle wheel collecting mechanism. FIG. 16A illustrates the robot system in closed mode. Robot system 1100 include primary robot frame 1110 and submodule 1120 configured to collect baseballs. A deployable rear platform 1130 is illustrated in a stored, up position, enabling robot system 1100 to act in a closed mode. FIG. 16B illustrates the robot system in open mode, with deployable rear platform 1130 in a deployed, horizontal position, capable of holding storage box 1150 and propelling baseball 1140 through opening 1160 into box 1150. FIG. 16C schematically illustrates exemplary internal mechanisms of the robot system in detail including a paddle wheel collecting mechanism. Robot system 1100 is illustrated, with internal motorized paddle wheel ball collector 1170 including a plurality of radial paddle portions 1172, which when rotated, contact and propel neighboring baseballs 1140 up ramp 1180, such that baseballs 1140 are propelled out of opening 1160. Paddle wheel ball collector can be described as a rotating drum with paddle extensions. It will be appreciated that the submodule of FIG. 16 can collect or be slightly modified to collect any number of balls, including but not limited to tennis balls, softballs, golf balls, volleyballs, soccer balls, footballs, basketballs, or any other similar objects.

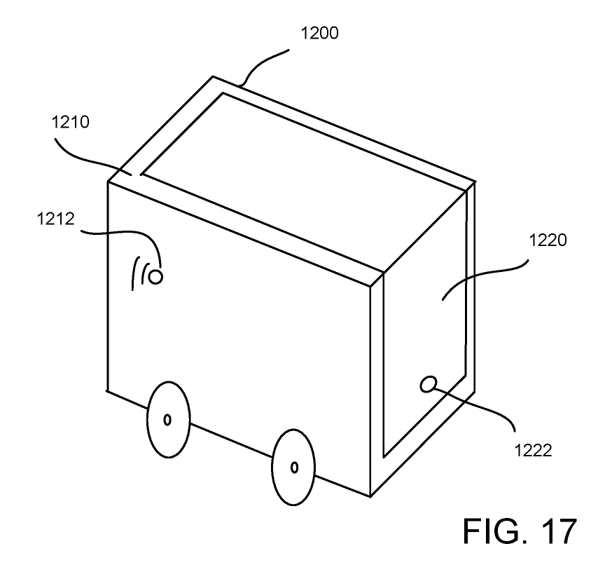

FIG. 17 illustrates an exemplary robot system including a locking cargo dispensing mechanism. Robot system 1200 is illustrated including primary robot frame 1210 and submodule 1220. Submodule 1220 includes internal storage and a locking door mechanism 1222, preventing accidental or unauthorized access to items stored within submoted 1220. Once the locking door mechanism 1222 is controlled into an open state, the stored items can be lifted out of the internal storage of submodule 1220. In another embodiment, submodule 1220 can have a lifting platform or an articulating arm to facilitate dispensing of the items provided within the internal storage of submodule 1220. An exemplary LIDAR sensing module 1212 is provide to guide robot system 1200 within its environment. Authorized access to the robot system can be provided based upon any number of identification methods, including passwords, fingerprints, keycards, voice recognition, signature recognition, or any other similar process.

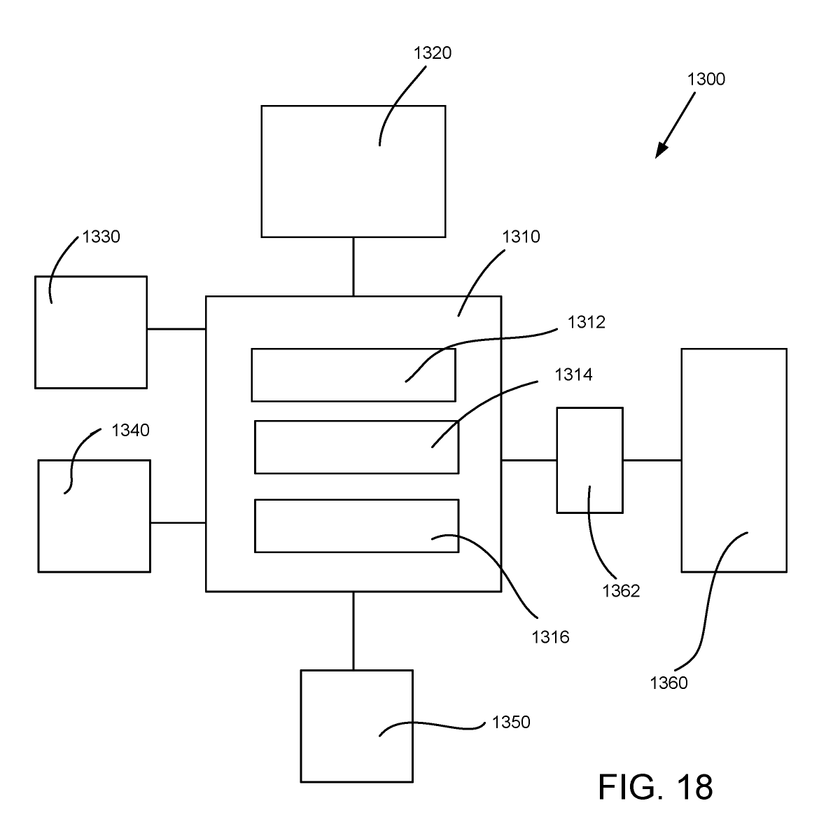

FIG. 18 schematically illustrates computerized control of an exemplary robot system. Computerized control system 1300 is illustrated, including processor device 1310, durable memory storage device 1350, communication device 1320, sensor arrays 1330, motive devices 1340, and submodule 1360 connected through power and data interface 1362.

Processor device 1310 includes a computing device known in the art useful for operating programmed code. Device 1310 included RAM memory and can access stored data through connection to memory storage device 1350. Memory storage device 1350 includes any hard drive, flash drive, or other similar device capable of receiving, storing, and providing access to digital data.

Processor device 1310 includes programming modules including task module 1312, sensing and movement module 1314, and submodule controller module 1316 which represent programmed functions that are exemplary of processes that can be carried out within processor device 1310, but are intended to be non-limiting examples of such processes. Task module 1312 receives commands to operate tasks such as picking up balls, transiting objects from one place to another, or cleaning a particular surface and carries out operations required to complete the assigned task. Sensing and movement module 1314 monitors inputs related to surfaces and obstacles close to the robot system and plans movement according to the monitored inputs. Submodule controller module 1316 coordinates operation of the submodule attached to the robot system with modules 1312 and 1314 in order to achieve the desired functions and accomplish the desired tasks. Modules 1312, 1314, and 1316 can include any related programming and related processes, and are intended only as non-limiting examples of how the system could be configured.

Sensor arrays 1330 include any camera, radar, LIDAR, ulstrasonic, or other similar devices that can provide the robot system with information about the operating environment around the robot system.

Motive devices 1340 include any motorized or mechanized devices available to the robot system to move the robot system around its environment. Motive devices 1340 can include locking mechanisms, either to hold the submodule in a docked state or to prevent unauthorized access to the submodule.

Communication device 1320 includes any wireless communication system required to receive command inputs to the robot system and provide outgoing reports of the status of the robot system, such as task completion, location, and battery state of charge.

Submodule 1360 includes any power or data operation requirements of the docked submodule for the robot system. Submodule 1360 is connected to the processor 1310 through power and data interface 1362, which enables disconnection of the submodule from the rest of the robot system.

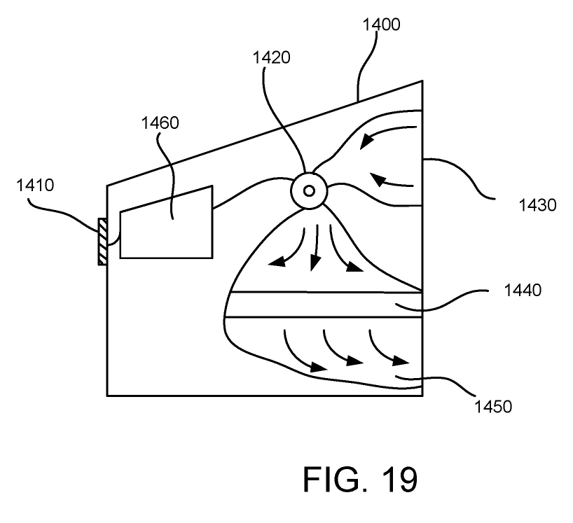

FIG. 19 schematically illustrates an exemplary submodule useful as an air purifier. Submodule 1400 is illustrated configured to filter a flow of air from a surrounding environment. Submodule 1400 includes power and data interface 1410, battery 1460, and blower motor and fan unit 1420. Blower motor and fan unit 1420 draws air from a surrounding environment in through air intake 1430, pushes the air through air filter unit 1440, and the purified air exiting the air filter unit 1440 exits through air exhaust 1450. The configuration of submodule 1400 is exemplary, and other configurations of air purifiers can be utilized in accordance with the disclosure.

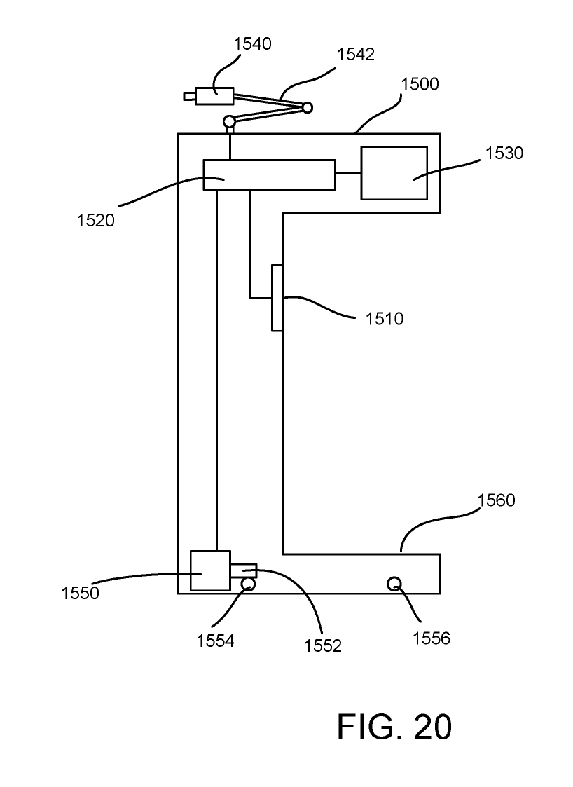

FIG. 20 schematically illustrates an exemplary primary robot frame. Primary robot frame 1500 is illustrated including a computerized control module 1520, a battery 1530, an electric machine or motor 1550, camera device 1540, cavity 1560 configured to receive and dock with a submodule, and a power and data interface 1510. Control module 1520 includes a processor and programming configured to operate processes and robot systems disclosed herein. Power and data interface 1510 includes electronic connectivity required to electronically connect robot frame 1500 to any of the disclosed submodules. Interface 1510 can include a mechanical locking feature to retain a docked submodule in place, or other mechanical locking features can be located within cavity 1560 in order to retain a docked submodule in place. Battery 1530 can include capacity to operate the entire robot system through desired functionality, or battery 1530 can include capacity to move robot frame 1500 from submodule to submodule during transitions, but otherwise depending upon battery power from the submodules to operate the functions of the submodules. Two wheel axles are illustrated, axle 1556 and axle 1554. Axle 1556 is unpowered and spins freely. Axle 1554 is powered by connection to motor 1550 through gear transmission unit 1552. Camera device 1540 is attached to the rest of robot frame 1500 through articulating arm 1542 which enables the robot system to change a perspective of camera device 1540 as required in different operational situations. A plurality of different camera devices can be used on one robot system.

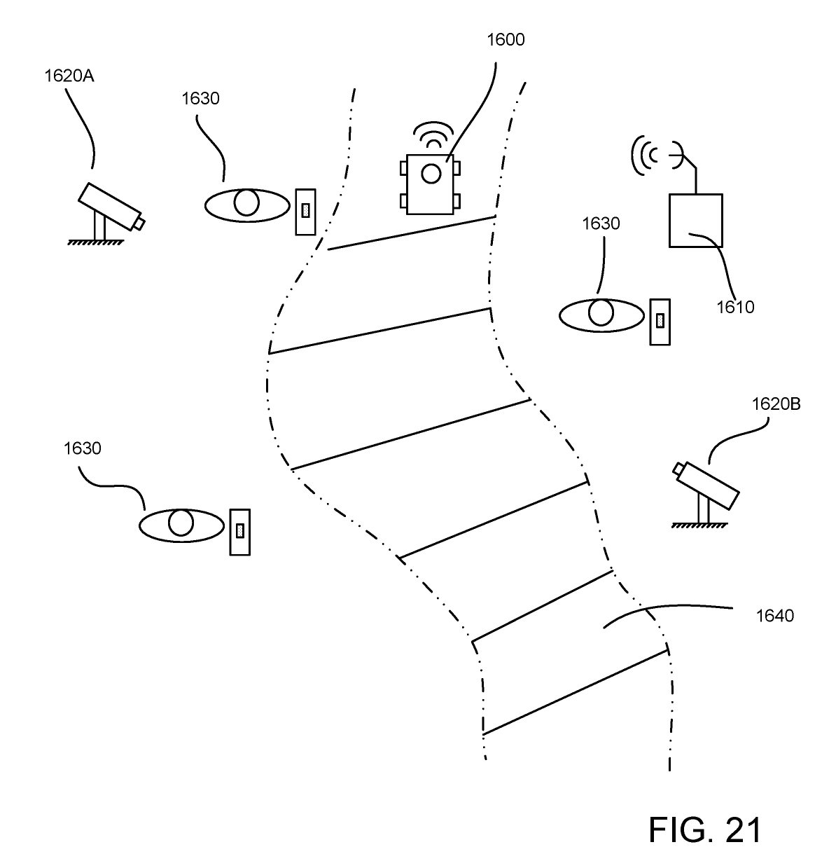

FIG. 21 illustrates coordination of exemplary data made available from external infrastructure systems with a robot system in closed mode to navigate the robot system through a complex environment. Robot system 1600 is illustrated within a busy environment, with a plurality of people 1630 illustrated carrying baggage. Infrastructure camera devices 1620A and 1620B are illustrated in communication with remote server system 1610. Remote server 1610 is illustrated in wireless communication with robot system 1600. Remote server system 1610 includes programming configured to use images from camera devices 1620A and 1620B to synthesize a clear path 1640 through which the robot system 1600 can travel and avoid contacting any of people 1630. Robot system 1600 can take instruction from remote server 1610, or robot system 1600 can take information from remote server 1610 and use onboard programming to prioritize information from remote server 1610 and information gathered by onboard sensors of robot system 1600 to determine a clear path 1640.

As disclosed herein, submodules can take on any number of functions. Submodules can be configured to gather balls such as tennis balls or basketballs, to vacuum clean a floor surface, to deliver items such as food, drink, or medication from within internal storage (a submodule with refrigeration or warming elements can be used for food and drink), hauling luggage, and to purify air though a filter device. Other functions are envisioned, such as security patrols through a building after-hours, checking in on patients in multiple rooms a hospital, feeding service dogs in a large facility, charging batteries in a plurality of stationary devices in a factory or other setting, and counting inventory in a store or automotive dealer. Any number of alternative functions can be served by the disclosed robot system, and the disclosure is not intended to be limited by the particular examples provided herein.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A system comprising a robot system, the robot system comprising:
a primary robot frame including a computerized control module providing control commands for the robot system, the primary robot frame including an outer perimeter; and
a plurality of submodules, each submodule capable of being selectively docked with the primary robot frame, the submodules each providing different functionality to the robot system;
wherein the submodules, when docked with the primary robot frame, fit within the outer perimeter, enabling the robot system to operate in a closed mode, wherein all movement of the robot system is based upon the outer perimeter.

2. The system of claim 1, the plurality of submodules each including a rechargeable battery.

3. The system of claim 1, wherein the robot system can selectively exit closed mode and operate in an open mode, wherein movement of the robot system is based upon the outer perimeter and objects connected to the robot system outside of the outer perimeter.

4. The system of claim 1, wherein one of the submodules is configured to collect balls strewn about a floor surface.

5. The system of claim 4, further comprising a deployable corral which can alternatively be retracted within the submodule or be extended outside of the submodule to hold the balls being collected.

6. The system of claim 4, further comprising a deployable platform that can be lowered to support a container to be filled with the balls being collected.

7. The system of claim 4, wherein the submodule comprises a rotating drum configured to propel the balls being collected inside of the submodule.

8. The system of claim 7, wherein the rotating drum comprises a plurality of paddle extensions.

9. The system of claim 7, further comprising an opening door on a front of the robot system.

10. The system of claim 1, wherein one of the submodules is configured as a vacuum cleaner to remove debris from a floor surface.

11. The system of claim 1, wherein one of the submodules is configured as an air purifier, removing air from an environment proximate to the robot system, propelling the air through an air filter device, and exhausting filtered air back to the environment.

12. The system of claim 1, wherein one of the submodules is configured to dispense an item from an internal storage area of the submodule.

13. The system of claim 12, wherein the submodule is electromechanically locked until the item is dispensed.

14. The system of claim 1, further comprising a plurality of camera devices configured to capture images of an environment proximate to the robot system.

15. The system of claim 14, wherein at least one of the camera devices is attached to one of a rotating gimbal device and an articulating arm device.

16. The system of claim 1, wherein the computerized control module comprises a cell phone attached to the robot system.
